(19) United States
(12) Patent Application Publication
(10) Pub. No.: US 2025/0280835 A1
(43) Pub. Date: Sep. 11, 2025

(54) EGG FREE, GLUTEN FREE COMPOSITION FOR BAKERY PRODUCTS AND METHOD OF MANUFACTURE

(71) Applicant: T. Marzetti Company, Westerville, OH (US)

(72) Inventor: Daniel Morin, Westerville, OH (US)

(21) Appl. No.: 19/070,095

(22) Filed: Mar. 4, 2025

Related U.S. Application Data
(60) Provisional application No. 63/561,702, filed on Mar. 5, 2024.
(60) Provisional application No. 63/669,411, filed on Jul. 10, 2024.
(60) Provisional application No. 63/675,924, filed on Jul. 26, 2024.

(51) Int. Cl. A21D 2/18; A21D 2/26; A21D 8/04

(52) U.S. Cl. CPC A21D 2/186; A21D 2/264; A21D 8/047

(57) ABSTRACT

The present disclosure is directed to novel method and formulation for producing egg free and gluten-free bread with a dough system providing an improved texture (softness, chewiness, moisture), shape (large baguette), appearance and taste, used for garlic toast and other applications. The formulation includes a combination of gluten-free flours (tapioca starch-modified, corn starch, potato starch, rice flour), leavening agent, binding agents (hemp heart protein and hydroxypropyl-methylcellulose HPMC), and additives to achieve a desired bread product suitable for individuals with gluten intolerance or celiac disease. The method involves specific steps to mix, proof, shape, and bake the dough to ensure optimal quality and consistency of bread slices used for garlic toast application and other bakery products.

### RELATED APPLICATIONS

This application claims priority under 35 U.S.C. § 119 (e) to U.S. Provisional Application Ser. No. 63/675,924 filed Jul. 26, 2024 and U.S. Provisional Application No. 63/561,702 filed Mar. 5, 2024 and U.S. Provisional Application No. 63/669,411 filed Jul. 10, 2024, which are expressly incorporated herein by reference in their entirety.

### FIELD OF THE DISCLOSURE

The present disclosure relates generally to bakery products, and more specifically to gluten free bakery products and methods of manufacture.

### BACKGROUND

The gluten-free market is one of the most dynamically developing food markets. Gluten intolerance and celiac disease are widespread conditions that require individuals to adhere to a strict gluten-free diet. Mintel (groove.mintel.co.uk) reports that 25% of US consumers are looking for ways to avoid gluten, 28% of US consumers say they always read the nutritional labels before purchasing packaged foods and 37% of US consumers are avoiding food/drink ingredients for medical reasons. Gluten is the third most popular claim in the category. Beyond Celiac Organization reports an estimated 1 in 133 Americans, or about 1% of the population, has celiac disease. However, recent screening studies point to a potentially higher prevalence than 1% in the United States. Beyond Celiac also reported Up to 6% of Americans have non-celiac gluten sensitivity. For consumers with celiac disease or sensitivity, there are no pharmaceutical treatments or cures for celiac disease. A 100% gluten-free diet is the only existing treatment for celiac disease or non-celiac gluten sensitivity today.

Commercially available gluten-free bread and other bakery products often lack the taste, texture, and shelf life of traditional wheat-based bakery products. There is a need for an improved formulation and production method to address these shortcomings and provide a high-quality gluten-free bread and other bakery products such as buns and rolls. Gluten, composed of gliadin and glutenin proteins found in various cereals and their processed products, plays a vital role in the rheological characteristics of yeast-leavened bakery items. These proteins possess low solubility in water. When combined with water and mixed, they create a cohesive and elastic network within the dough. This network effectively traps gas released during fermentation. To achieve optimal bread volume, this gluten structure must effectively capture and expand with the carbon dioxide generated by yeast activity throughout the fermentation process. This allows for:
The dough to be more extensible, stretchable and elastic allowing for easier handling and shaping;
Improved mix tolerance, meaning the dough can withstand the mixing process without becoming overly tough or breaking down;
Achieving better rounding and molding of the dough, resulting in more uniform and attractive final products;
Enhancement of the cell structure of the finished product, leading to a lighter texture and improved crumb;
Facilitating fermentation and expansion during proofing and baking, contributing to the overall volume and texture of the bread

Amino acid composition of these proteins, their molecular interactions (intra- and inter-), respective ratio in total gluten, as well as the proportion of low molecular weight (LMW) glutenin subunits and high-molecular weight (HMW) glutenin subunits are all contributing factors to gluten performance and overall quality. Ref 1 Shewry, P. R., et al. “Wheat Grain Proteins.” Wheat Chemistry and Technology, 4th edition, AACC International, Inc., 2009, pp. 223-278, which is hereby incorporated by reference in its entirety.

Many studies have been focused on quality improvements of gluten-free bread related to shelf life, but an important aspect is a development of comparable finished good experience for the consumer versus bread leaders of frozen bread categories. Formulating an egg free gluten-free bread presents numerous challenges in replicating the properties of traditional wheat-based counterparts. These hurdles encompass issues like challenging machinability, achieving optimal density and fermentation without collapse during proofing and baking, combating a brittle and powdery texture, and overcoming starchy flavors. Existing commercial gluten-free garlic toast and other bakery products, such as buns and rolls, made from a batter system, often fall short in taste, texture, and appearance compared to the leading wheat-based options. This batter system production method involves creating a liquid-like mixture rather than a traditional dough. As a result, the taste and texture of these gluten-free products often differ significantly from those made from a dough system. The main reason for this disparity lies in the fundamental differences between batters and doughs. Batter-based products tend to have a denser, more uniform texture with a softer crumb. On the other hand, dough-based products, such as regular frozen garlic toast or other bakery items, offer a more distinct texture, with a crispy crust and a tender, airy interior. The absence of gluten in gluten-free batters also contributes to the difference in taste and texture. Gluten provides elasticity and structure to dough, allowing it to rise and develop a desirable chewiness. Without gluten, batter-based products may lack the same level of volume, structure, and chewy texture characteristic of traditional bakery items. Moreover, traditional dough conditioners commonly employed in the bakery industry prove ineffective in gluten-free formulations and processes.

### SUMMARY

The present disclosure may comprise one or more of the following features and combinations thereof.

In illustrative embodiments, the present disclosure is directed to a novel formulation and method for producing egg free and gluten-free bread and other bakery products using a dough system. The formulation comprises a blend of gluten-free flours such as tapioca, corn, potato and/or rice flours, along with a leavening agent (yeast). Binding agents hemp heart protein and hydroxypropyl-methylcellulose HPMC are included to mimic the cohesive properties of gluten. Additional additives such as sugars, salt, and fat may be incorporated to enhance flavor, texture, and as processing aids. The dough is mixed, kneaded, shaped into bread loaves, bun or roll format, and then proofed and baked to produce a high-quality gluten free bread or other bakery product with a soft, airy texture and delicious flavor.

In illustrative embodiments, the method and formulation for producing egg free gluten-free bread with a dough system providing an improved texture (softness, chewiness, moisture), shape (large baguette, bun, or roll), appearance and taste, used for garlic toast application. The formulation includes a combination of gluten-free flours (tapioca starch-modified, corn starch, potato starch, and/or rice flour), leavening agent, binding agents (hemp heart protein and hydroxypropyl-methylcellulose HPMC), and additives to achieve a bread product suitable for individuals with gluten intolerance or celiac disease. The method involves specific steps to mix, shape, proof, and bake the dough to ensure optimal quality and consistency of bread slices used for Garlic Toast application and other bakery products. These and other features of the present disclosure will become more apparent from the following description of the illustrative embodiments.

### BRIEF DESCRIPTION OF THE DRAWINGS

FIG. 1 is a flow chart illustrating a mixing process for making an egg free gluten free bread in accordance with various embodiments herein;

FIG. 2 is a flow chart of a bread make-up process for making an egg free gluten free bread in accordance with various embodiments herein; and

FIG. 3 is a graph showing the bake profile that captures critical baking steps for an egg free gluten free bread in accordance with various embodiments herein.

### DETAILED DESCRIPTION

For the purposes of promoting an understanding of the principles of the disclosure, reference will now be made to a number of illustrative embodiments illustrated in the drawings and specific language will be used to describe the same.

Gluten free grain based items have been improving with the increase offering of starch based gluten free flour options. However, there is still an unmet need for a non-compromise option versus current frozen bread leaders in term of the overall experience vs wheat gluten based breads; texture, taste, shape, and appearance.

The present disclosure teaches combining a unique set of ingredients and novel mixing/forming processes to arrive at the desired product. The present disclosure utilizes hemp (Cannabis sativa L.) protein preparation to enrich the recipe for gluten-free bread. Hemp protein consists primarily of albumin and edestin (edistin), rich in essential amino acids (ref 2; Callaway, 2004). J. C. Callaway. “Hempseed as a nutritional resource; An overview”. Volume 140, 2004, page 65-72.

| Amino | Hemp | |
|---|---|---|
| Acids | Seed | Wheat |
| Essential | | |
| His | 3.07 | 1.7 |
| Arg | 12.68 | 4.1 |
| Thr | 3.79 | 2.3 |
| Val | 5.27 | 3.6 |
| Met | 2.14 | 1.1 |
| Lys | 3.78 | 2 |
| Ile | 4.23 | 3.2 |
| Leu | 7.12 | 6.7 |
| Phe | 4.76 | 2.3 |
| Non-essential | | |
| Trp | 0.76 | 1.2 |
| Asp | 11.34 | 4.5 |
| Ser | 5.57 | 4.2 |
| Glu | 18.41 | 36.1 |
| Gly | 4.74 | 3.3 |
| Ala | 4.89 | 2.8 |
| Pro | 2.66 | 8.4 |
| Cys | 1.22 | 2 |
| Tyr | 3.79 | 4 |
| Reference | [76] | |

Hemp is used as a structure-enhancing ingredient in this egg free, gluten free bread. The method created focused on mixing properties, and machinability of the dough. The hemp amino acids enhance the quality of this invention by improving the dough rheology and texture.

Formulations were developed with varying concentrations of hemp heart protein powder, replacing a portion of traditional gluten free formulations to achieve unexpected results in dough characteristics. Dough characteristics including elasticity and extensibility were evaluated by hand at mixing and by measurement of the bread quality parameters such as volume, crumb structure and sensory attributes (bite). The incorporation of hemp amino acids by using hemp heart protein powder resulted in improved dough handling properties. Breads containing this hemp concentration had enhanced volume and crumb structure, with finer texture and richer flavor.

A widely used hydrocolloid, hydroxypropyl methycellulose (HPMC) were added with varying concentrations. The addition of HPMC resulted in significant improvements in bread volume and moisture retention; providing better gas retention during fermentation and baking (eliminating the collapsing effect observed in a gluten free dough system). The hydrocolloid properties improve water retention (creating a more favorable environment for yeast activity), viscosity (which helps trap gas bubbles produced by yeast fermentation), structural support (preventing collapse and ensuring that gas bubbles remain trapped within the bread structure) and delay the gelatinization of starch in the dough (allowing for a more extended fermentation period). The yeast has a more favorable environment and a prolonged time to growth, resulting in increased gas production.

The incorporation of hemp heart protein combined with hydroxypropyl methylcellulose enabled and enhanced proper dough machinability, preventing collapse and effectively trapping gas bubbles produced by the yeast. This resulted in increased volume, a lighter/airier texture, and enhanced taste.

Determining the appropriate amount of liquid in a gluten-free bread formulation relied heavily on the properties of the starch used, which typically called for an equivalent of absorption weight than powder. Traditional gluten free bread formulation called for 100% water based on 100% “flour” based formulation, making the formulation a batter versus a dough. A water reduction will occasion a dense loaf while an excess water will create a sticker dough that won't be machinable on an industrial line.

Scaling up gluten-free production often requires using equipment in ways completely unlike baking with conventional dough. Unlike traditional dough, gluten-free dough lacks the elasticity and structure provided by gluten proteins. This means that traditional baking equipment and processes do not yield satisfactory results when producing gluten-free products on a larger scale. For instance, the mixing process for gluten-free dough need to be adjusted to ensure thorough blending of ingredients without overworking the dough. The addition of the ingredient is critical as well as the mixing time for speed (force applied to the dough).

Additionally, dough temperature, proofing and baking times and temperatures need to be modified to achieve the desired texture and rise in gluten-free products. Moreover, the choice of equipment becomes crucial in gluten-free production. Specialized machinery designed to handle gluten-free dough, such as mixers with gentle mixing action and dough dividers with adjustable settings, are necessary to ensure consistent product quality and minimize production challenges.

Scaling up gluten-free production requires careful consideration of equipment selection, process optimization, and quality control measures to ensure the successful and efficient production of high-quality gluten-free products on a larger scale.

The egg free gluten-free bread formulation comprises the following ingredients in specific proportions (based on Bakery %):

### Gluten-Free Flours <100%

(10-30% modified tapioca starch and preferably 24-26%, 5-20% corn starch and preferably 12-14%, and 5-40% potato starch and preferably 14-16%), for a total flour percentage from about 38.25% to about 64.73%
0-10% rice flour

### Leavening Agents

1-10% Activated yeast, and preferably 1.3-1.75% and more preferably 1.4%.

### Binding Agents

1-5% hydroxypropyl methylcellulose (HPMC) Gumplete MC-0916 and preferably 2.175-3.625% and more preferably 2.9%
1-5% Hemp Heart protein and preferably 2.475-4.125% and more preferably 3.3%

### Additives

1-10% Granulated Sugar and preferably 2.475-4.125% and more preferably 3.3%
0-2% Salt and preferably 0.75-1.25% and more preferably 1.0%
2-10% Glucose and preferably 2.175-3.625% and more preferably 2.9
2-5% Fat in the form of oil and preferably 2.85-4.75% and more preferably 3.8%
22-45% Water and preferably 23.775-39.625% and more preferably 31.7%
   The composition can also include between 0 and 10 ppm gluten.

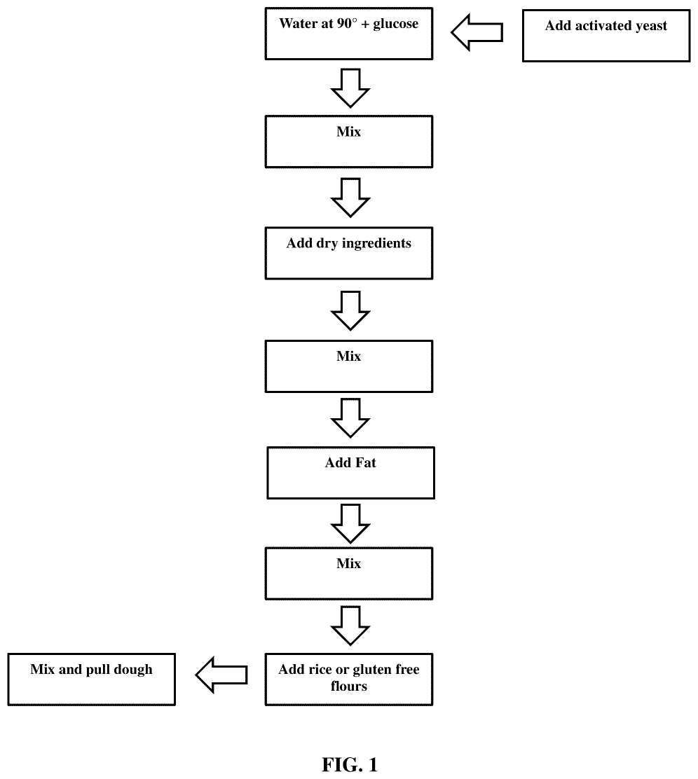

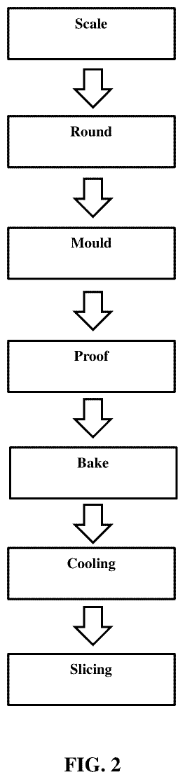

The method of producing the gluten-free bread involves the following steps as shown in FIGS. 1 and 2:
Combine water and glucose to activated yeast and mix;
Add: Combine the gluten-free flours, leavening agents, binding agents, and additives in a mixing bowl with water, glucose and yeast and mix to form a dough;
Add fat to dough mixture and mix further;
Add gluten-free flours or rice flour to dough mixture and mix further;
Shaping: Shape the proofed dough into desired large baguette bread loaf shapes;
Proofing: Allow the dough to proof in a warm environment to activate the leavening agents and develop flavor;
Baking: Bake the shaped dough in an oven at a specific temperature (350 degrees F.) and duration (30-35 minutes) until fully cooked and golden brown;
Cooling: Allow the baked bread to cool on a cooling tour conveyor to prevent moisture buildup and maintain texture.

Issues encountered during the development on this invention, all of which were overcome by the present formulation and method:
Dough too sticky to handle post mixing
The dough hasn't achieved enough elasticity to rise
Loaf sinks/collapses in the middle while baking

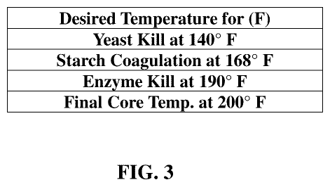

The temperatures used for the various ingredients during the method of producing the gluten free bread are shown in FIG. 3. The disclosed method and formulation offer several advantages over existing gluten free bread products. First, it is suitable for individuals with egg allergies or gluten intolerance; Second, it improves the taste and texture resembling to traditional wheat-based bread used for garlic toast; soft and airy texture; Third, it mimics bread production vs gluten free batter formulation; versatile dough system allows for various bread shapes and sizes; Fourth, it is a customizable formulation to accommodate various dietary preferences and restrictions; and fifth, it is a scalable production process suitable for commercial manufacturing.

The method and formulation described herein provide a novel approach to producing high-quality egg free gluten-free bread with improved taste, texture, shape and appearance. This innovation has significant implications for individuals with gluten intolerance or celiac disease, as well as the food industry at large.

A composition for producing egg and gluten free bread products, comprising at least about 38% by weight gluten free flour based on the total weight of the composition, at least about 1% activated yeast based on the total weight of the composition, at least about 1% hydroxypropyl methylcellulose based on the total weight of the composition; and at least about 1% hemp hear protein based on the total weight of the composition. The gluten free flour comprises one or more of a tapioca starch, corn starch, and potato starch.

The gluten free flour comprises from about 10% to about 30% modified tapioca starch based on the total weight of the composition. The gluten free flour comprises from about 5% to about 20% corn starch based on the total weight of the composition. The gluten free flour comprises from about 5% to about 40% potato starch based on the total weight of the composition. The gluten free flour comprises from about 10% to about 30% modified tapioca starch based on the total weight of the composition. The gluten free flour comprises from about 1% to about 10% rice flour based on the total weight of the composition.

The hydroxypropyl methylcellulose is present at an amount from about 1% to about 5% of the total weight of the composition. The hemp heart protein is present at an amount from about 1% to about 5% of the total weight of the composition. The hydroxypropyl methylcellulose is present at an amount from about 2% to about 3.6% of the total weight of the composition. The hemp heart protein is present at an amount from about 2.4% to about 4.2% of the total weight of the composition. The composition comprises one or more additional ingredients for making the bread products, selected from water, sugar, salt, oil and glucose. The composition is in the form of a wet mixture or premix for producing the bread products. The composition is in the form of a dry mixture or premix for producing the bread products. The composition can be formed into a dough and a leavened or unleavened gluten-free bread product.

The dough is produced by combining the water and the glucose with the activated yeast and mixing to form an activated yeast combination. Next, a user combines the gluten-free flour, the hydroxypropyl methylcellulose, the hemp heart protein and the additional ingredients in a mixing bowl or other container with the activated yeast combination and mix to form a dough mixture. Next fat in the form of oil, lard, or shortening is added to dough mixture and mixed further. Next a user adds the gluten-free flour to the dough mixture and mixes further. Once mixed, the dough is shaped into one or more bread loaf shapes. Next the dough is allowed to proof. Once proofed it is then baked to form a final bread product.

A composition for producing egg and gluten free bread products, that includes at least about 38% by weight gluten free flour based on the total weight of the composition, wherein the gluten free flour comprises one or more of a tapioca starch, corn starch, and potato starch. The composition also includes at least about 1% activated yeast based on the total weight of the composition. The composition also includes at least about 1% hydroxypropyl methylcellulose based on the total weight of the composition and at least about 1% hemp heart protein based on the total weight of the composition. The composition also includes at least 22% water based on the total weight of the composition and at least 1% sugar based on the total weight of the composition. The composition also includes at least 2% oil based on the total weight of the composition and at least 2% glucose based on the total weight of the composition.

A method of preparing egg and gluten-free dough product includes the steps of mixing together water, glucose, and a leavening agent to form an active leavening component, combining gluten free flour, hydroxypropyl methylcellulose, hemp heart protein, water, sugar, and salt with the leavening component and mixing together to form a gluten free dough mixture, and adding oil to the dough mixture. The gluten-free flour constituting at least 38 wt. % of the gluten-free dough and the leavening agent constituting at least 1 wt. % of said gluten-free dough. The hydroxypropyl methylcellulose constituting at least 1 wt. % of said gluten-free dough and the hemp heart protein constituting at least 1 wt. % of said gluten-free dough. The water constituting at least 22 wt. % of said gluten-free dough and the oil constituting at least 2 wt. % of said gluten-free dough. The sugar constituting at least 1 wt. % of the egg and gluten-free dough. The method also includes the steps of shaping the gluten-free dough mixture; and proofing in a warm environment to activate the leavening agent.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A composition for producing egg and gluten free bread products, comprising:
at least about 38% by weight gluten free flour based on the total weight of the composition;
at least about 1% activated yeast based on the total weight of the composition;
at least about 1% hydroxypropyl methylcellulose based on the total weight of the composition; and
at least about 1% hemp hear protein based on the total weight of the composition.

2. The composition of claim 1, wherein the gluten free flour comprises one or more of a tapioca starch, corn starch, and potato starch.

3. The composition of claim 1, wherein the gluten free flour comprises from about 10% to about 30% modified tapioca starch based on the total weight of the composition.

4. The composition of claim 1, wherein the gluten free flour comprises from about 5% to about 20% corn starch based on the total weight of the composition.

5. The composition of claim 1 wherein the gluten free flour comprises from about 5% to about 40% potato starch based on the total weight of the composition.

6. The composition of claim 2, wherein the gluten free flour comprises from about 10% to about 30% modified tapioca starch based on the total weight of the composition.

7. The composition of claim 2, wherein the gluten free flour comprises from about 1% to about 10% rice flour based on the total weight of the composition.

8. The composition of claim 2, wherein the hydroxypropyl methylcellulose is present at an amount from about 1% to about 5% of the total weight of the composition.

9. The composition of claim 8, wherein the hemp heart protein is present at an amount from about 1% to about 5% of the total weight of the composition.

10. The composition of claim 2, wherein the hydroxypropyl methylcellulose is present at an amount from about 2% to about 3.6% of the total weight of the composition.

11. The composition of claim 8, wherein the hemp heart protein is present at an amount from about 2.4% to about 4.2% of the total weight of the composition.

12. The composition according to claim 2, wherein the composition comprises one or more additional ingredients for making the bread products, selected from water, sugar, salt, oil and glucose.

13. The composition according to claim 1, wherein the composition is in the form of a wet mixture or premix for producing the bread products.

14. The composition according to claim 1, wherein the composition is in the form of a dry mixture or premix for producing the bread products.

15. A dough comprising a composition according to claim 12.

16. A gluten-free bread product produced with a composition according to claim 1.

17. A bread product according to claim 16, wherein the bread product comprises leavened or unleavened bread.

18. The dough of claim 15 produced from the following steps:
first, combine the water and the glucose to the activated yeast and mixing to form an activated yeast combination;
next, combine the gluten-free flour, the hydroxypropyl methylcellulose, the hemp heart protein and the additional ingredients in a mixing bowl with the activated yeast combination and mix to form a dough mixture;
next add fat to dough mixture and mix further;
next add the gluten-free flour to the dough mixture and mix further;
next shape the proofed dough into one or more bread loaf shapes;
next, allow the dough to proof.

19. A composition for producing egg and gluten free bread products, comprising:
at least about 38% by weight gluten free flour based on the total weight of the composition, wherein the gluten free flour comprises one or more of a tapioca starch, corn starch, and potato starch;
at least about 1% activated yeast based on the total weight of the composition;
at least about 1% hydroxypropyl methylcellulose based on the total weight of the composition;
at least about 1% hemp heart protein based on the total weight of the composition; and
at least 22% water based on the total weight of the composition;
at least 1% sugar based on the total weight of the composition;
at least 2% oil based on the total weight of the composition; and
at least 2% glucose based on the total weight of the composition.

20. A method of preparing egg and gluten-free dough product comprising the steps of:
i) mixing together water, glucose, and a leavening agent to form an active leavening component;
ii) combining gluten free flour, hydroxypropyl methylcellulose, hemp heart protein, water, sugar, and salt with the leavening component and mixing together to form a gluten free dough mixture;
iii) adding oil to the dough mixture;
the gluten-free flour constituting at least 38 wt. % of the gluten-free dough;
the leavening agent constituting at least 1 wt. % of said gluten-free dough;
the hydroxypropyl methylcellulose constituting at least 1 wt. % of said gluten-free dough;
the hemp heart protein constituting at least 1 wt. % of said gluten-free dough;
the water constituting at least 22 wt. % of said gluten-free dough;
the oil constituting at least 2 wt. % of said gluten-free dough;
the sugar constituting at least 1 wt. % of the egg and gluten-free dough;
iv) shaping the gluten-free dough mixture; and
v) proofing in a warm environment to activate the leavening agent.
